(19) United States
(12) Patent Application Publication
(10) Pub. No.: US 2025/0335204 A1
(43) Pub. Date: Oct. 30, 2025

(54) CONFIGURATION METHOD, LOGISTICS SERVICE SCHEME DETERMINATION METHOD AND COMPUTING DEVICE

(71) Applicant: Hangzhou Alibaba International Internet Industry Co., Ltd., Hangzhou (CN)

(72) Inventors: Huan ZHANG, ShenZhen (CN); Shuai ZHU, ShenZhen (CN)

(21) Appl. No.: 19/260,255

(22) Filed: Jul. 3, 2025

Related U.S. Application Data
(63) Continuation of application No. PCT/CN2024/071231, filed on Jan. 8, 2024.

(30) Foreign Application Priority Data
Jan. 11, 2023 (CN) 202310042812.1

(51) Int. Cl. G06F 9/4401

(52) U.S. Cl. CPC G06F 9/4401

(57) ABSTRACT

Embodiments of the present application provide a configuration method, which comprises, in response to a user's configuration operation, determining at least one evaluation factor configured by the user's configuration operation, at least one evaluation rule configured for the at least one evaluation factor, and constraint relationship among the at least one evaluation rule; generating a recommendation rule based on the at least one evaluation rule respectively corresponding to the at least one evaluation factor and the constraint relationship among the at least one evaluation rule; wherein the recommendation rule is used to determine a matching degree between a target user and each of a plurality of logistics service schemes, so as to determine, based on the matching degree, at least one target logistics service scheme to be recommended for the target user.

### CROSS-REFERENCE TO RELATED APPLICATION

This application is a Continuation Application of International Patent Application No. PCT/CN2024/071231, filed on Jan. 8, 2024, which is based on and claims priority to and benefits of Chinese patent application number 202310042812.1, filed on Jan. 11, 2023, titled “CONFIGURATION METHOD, LOGISTICS SERVICE SCHEME DETERMINATION METHOD AND COMPUTING DEVICE.” The entire content of the aforementioned applications is incorporated herein by reference.

### TECHNICAL FIELD

The embodiments of the present application relate to the field of electronic technology, and more particularly, to a configuration method, a logistics service scheme determination method, and a computing device.

### BACKGROUND

With the development of Internet technology, an increasing number of customers are using online resources to exchange objects. This involves logistics service providers carrying out object transportation according to the provided logistics service scheme to deliver the objects supplied by the providers to the customers.

Since there may be many logistics service providers offering logistics service schemes, and each provider may offer a plurality of schemes, users typically select a logistics service scheme from a large number of available options to trigger the transportation of objects using the chosen scheme.

However, this method of determining a logistics service scheme is not precise, which may lead to a plurality of online interactions between the customer and the object provider. Additionally, it increases the system's computational load, thereby affecting system performance.

### SUMMARY

The embodiments of the present application provide a configuration method, a logistics service processing method, and a computing device to address the technical problem in the prior art where the determination of logistics service schemes is inaccurate, thereby affecting system performance.

In a first aspect, the embodiments of the present application provide a configuration method, comprising:
in response to a user's configuration operation, determining at least one evaluation factor configured by the user's configuration operation, at least one evaluation rule configured for the at least one evaluation factor, and constraint relationship among the at least one evaluation rule;
generating a recommendation rule based on the at least one evaluation rule respectively corresponding to the at least one evaluation factor and the constraint relationship among the at least one evaluation rule;
wherein the recommendation rule is used to determine a matching degree between a target user and each of a plurality of logistics service schemes, so as to determine, based on the matching degree, at least one target logistics service scheme to be recommended for the target user.

Optionally, the method further includes at least one of the following operations:
determining a configured recommendation mode in response to the user's configuration operation;
determining at least one configured recommendation field in response to the user's configuration operation;
and,
determining a configured logistics service type in response to the user's configuration operation;
wherein generating the recommendation rule based on the at least one evaluation rule respectively corresponding to the at least one evaluation factor and the constraint relationship among the at least one evaluation rule includes:
generating the recommendation rule based on the at least one evaluation rule respectively corresponding to the at least one evaluation factor and the constraint relationship among the at least one evaluation rule, in combination with at least one of the recommendation mode, the at least one recommendation field, and the logistics service type;
wherein the recommendation mode is used to indicate that the target logistics service scheme is recommended to the target user according to the recommendation mode; and
wherein the target logistics service scheme corresponds to field data of the at least one recommendation field for generating recommendation information corresponding to the target logistics service scheme.

Optionally, in response to a user's configuration operation, determining at least one evaluation factor configured by the user's configuration operation, at least one evaluation rule configured for the at least one evaluation factor, and constraint relationship among the at least one evaluation rule includes:
providing a configuration interface;
providing an evaluation factor configuration control on the configuration interface;
determining at least one configured evaluation factor in response to a configuration operation on the evaluation factor configuration control;
providing a rule configuration control corresponding to the at least one evaluation factor on the configuration interface;
determining at least one configured evaluation rule and the constraint relationship among the at least one evaluation rule in response to a configuration operation on the rule configuration control corresponding to the evaluation factor.

Optionally, the rule configuration control includes a relationship configuration control, a type configuration control, a content configuration control, and a score configuration control;
the step of determining at least one configured evaluation rule and the constraint relationship among the at least one evaluation rule in response to a configuration operation on the rule configuration control corresponding to the evaluation factor includes:
providing relationship configuration prompt information on the configuration interface;
in response to a trigger operation on the relationship configuration prompt information, displaying the relationship configuration control on the configuration interface;
in response to a configuration operation on the relationship configuration control, determining a configured constraint relationship;
providing rule configuration prompt information on the configuration interface;
in response to a trigger operation on the rule configuration prompt information, displaying rule type configuration control, content configuration control, and score configuration control for the constraint relationship on the configuration interface;
in response to a configuration operation on the type configuration control, determining a configured rule type;
in response to a configuration operation on the content configuration control, determining a configured rule content;
in response to a configuration operation on the score configuration control, determining a configured score determination method;
generating an evaluation rule based on the rule type, the rule content, and the score determination method; and
determining one or more evaluation rules configured under the constraint relationship.

Optionally, the evaluation factor configuration control includes an evaluation factor configuration sub-control and a total score configuration sub-control;
the step of determining at least one evaluation factor in response to a configuration operation on the evaluation factor configuration control includes:
determining at least one evaluation factor in response to a configuration operation on the evaluation factor configuration sub-control;
determining the corresponding weighted total score in response to a configuration operation on the total score configuration control corresponding to the evaluation factor;
wherein the score determination method of the evaluation rule is a proportion within the weighted total score.

Optionally, the method further includes:
displaying rule prompt information corresponding to a plurality of recommendation rules on the configuration interface, where the rule prompt information includes at least one operation control;
in response to a trigger operation on any operation control corresponding to any recommendation rule, processing the recommendation rule according to the corresponding operation type.

Optionally, the at least one operation control includes a start control, a delete control, a view control, an edit control, and/or a test control;
the rule prompt information further includes status prompt information; the status prompt information includes operational status, test status, disabled status, and so on.

Optionally, the method further includes one or more of the following operations:
providing a field configuration control on the configuration interface, and determining at least one configured recommendation field in response to a configuration operation on the field configuration control;
providing a mode configuration control on the configuration interface, and determining the configured recommendation mode in response to a configuration operation on the mode configuration control;
providing a service type configuration control on the configuration interface, and determining the configured logistics service type in response to a configuration operation on the service type configuration control;
the step of generating recommendation rules based on the at least one evaluation rule corresponding to each evaluation factor and the constraint relationships among the evaluation rules includes:
generating recommendation rules based on the at least one evaluation rule corresponding to each evaluation factor and the constraint relationships among the evaluation rules, in combination with the recommendation mode, the at least one recommendation field, and at least one of the logistics service types.

In a second aspect, an embodiment of the present application provides a method for determining a logistics service scheme, comprising:
determining a recommendation rule corresponding to a plurality of logistics service schemes, wherein the recommendation rule is generated based on at least one evaluation factor respectively corresponding to at least one evaluation rule and constraint relationship among the at least one evaluation rule;
based on attribute data of the at least one evaluation factor respectively corresponding to the plurality of logistics service schemes, calculating a degree of matching between each of the logistics service schemes and a target user according to the at least one evaluation rule respectively corresponding to the at least one evaluation factor and the constraint relationship among the at least one evaluation rule;
determining at least one target logistics service scheme based on the degree of matching between each of the plurality of logistics service schemes and the target user; wherein the at least one target logistics service scheme is to be recommended to the target user.

Optionally, the step of determining a recommendation rule corresponding to a plurality of logistics service schemes includes:
determining a plurality of logistics service schemes that match the target user based on user characteristic data of the target user;
determining the recommendation rule respectively corresponding to the plurality of logistics service schemes based on the logistics service type respectively corresponding to the plurality of logistics service schemes.

Optionally, the step of calculating a degree of matching between each of the logistics service schemes and a target user based on attribute data of at least one evaluation factor respectively corresponding to the plurality of logistics service schemes, according to the at least one evaluation rule respectively corresponding to the at least one evaluation factor and the constraint relationship among the at least one evaluation rule, includes:
for any given logistics service scheme, determining attribute data respectively corresponding to the at least one evaluation factor according to the at least one evaluation factor in the recommendation rule corresponding to the logistics service scheme;
for any given evaluation factor, based on the attribute data corresponding to any one of the evaluation factors, calculating a matching score corresponding to any one of the evaluation rules corresponding to the evaluation factor, based on the attribute data corresponding to the evaluation factor;
fusing the matching score respectively corresponding to the at least one evaluation rule according to the constraint relationship of the at least one evaluation rule corresponding to the evaluation factor, to obtain an evaluation score corresponding to the evaluation factor;
fusing the evaluation score respectively corresponding to the at least one evaluation factor to obtain a total evaluation score corresponding to the logistics service scheme;
using the total evaluation score as the degree of matching between the logistics service scheme and the target user.

Optionally, the at least one evaluation rule corresponding to the evaluation factor includes one or more of the following:
a score determination method based on similarity conditions satisfied between attribute preference data of the evaluation factor corresponding to the target user and the attribute data of the evaluation factor corresponding to a current logistics service scheme score determination method;
a score determination method corresponding to different preset tags included in the current logistics service scheme score determination method;
a score determination method corresponding to a ranking position of attribute data of the current logistics service scheme among a plurality of logistics service schemes' score determination method;
a score determination method corresponding to a time range in which the difference between effective time of attribute data of the current logistics service scheme and current time falls;
wherein calculating the matching score corresponding to any one of the evaluation rules based on the attribute data of any one evaluation factor corresponding to the logistics service scheme includes:
determining the corresponding matching score based on the attribute data of the evaluation factor and the score determination method corresponding to a similarity condition satisfied with the attribute preference data of the evaluation factor corresponding to the target user score determination method;
determining the corresponding matching score according to the score determination method corresponding to at least one tag included in the logistics service scheme score determination method;
determining the corresponding matching score based on a ranking position of the attribute data of the evaluation factor among the plurality of logistics service schemes according to the corresponding score determination method score determination method;
or,
determining the corresponding matching score based on the time range in which the difference between the effective time of the attribute data of the evaluation factor and the current time falls according to the corresponding score determination method score determination method.

Optionally, the method further includes:
recommending the at least one target logistics service scheme to the target user according to a recommendation method in the recommendation rule.

Optionally, the method further includes:
determining at least one recommendation field in the recommendation rule;
generating recommendation information based on field data of the at least one recommendation field corresponding to the target logistics service scheme;
sending the recommendation information respectively corresponding to the at least one target logistics service scheme to the target user.

Optionally, the method further includes:
receiving a logistics service request sent by the target user for any target logistics service scheme;
generating a logistics service order;
sending the logistics service order to a logistics service provider corresponding to the target logistics service scheme.

Optionally, the user characteristic data includes user profile data; determining a plurality of logistics service schemes that match the target user based on the user characteristic data of the target user includes:
determining the user's preferred departure location, destination, logistics service provider, price range, and/or transit time range based on the user profile data of the target user;
determining a plurality of logistics service schemes that meet one or more of the following matching conditions; the one or more matching conditions include:
the service coverage matches the departure location or the destination, including the logistics service provider, the transportation price falls within the price range, and the transit time is within the transit time range.

Optionally, the method further includes:
generating a service recommendation task based on a service recommendation request sent by the target user; generating a service recommendation task when the target user performs a target action; or generating a service recommendation task upon detecting a target event;
determining the recommendation rules corresponding to a plurality of logistics service schemes includes:
determining the recommendation rules corresponding to a plurality of logistics service schemes in response to the service recommendation task.

In a third aspect, an embodiment of the present application provides a computing device, comprising a processing component and a storage component;
the storage component stores one or more computer instructions; the one or more computer instructions are configured to be invoked and executed by the processing component to implement the configuration method as described in the first aspect above or to implement the logistics service scheme determination method as described in the second aspect above.

In a fourth aspect, an embodiment of the present application provides a computer storage medium storing a computer program, which, when executed by a computer, implements the configuration method as described in the first aspect above or the logistics service scheme determination method as described in the second aspect above.

In the embodiments of the present application, the recommendation rules corresponding to the logistics service schemes are generated based on at least one evaluation factor, each corresponding to at least one evaluation rule and the constraint relationships between the evaluation rules. Based on the attribute data of at least one evaluation factor corresponding to any logistics service scheme, the matching degree between the logistics service scheme and the target user is calculated according to the at least one evaluation rule corresponding to the evaluation factors and the constraint relationships between the evaluation rules. Thus, based on the matching degrees of the plurality of logistics service schemes with the target user, at least one target logistics service scheme is determined, which is recommended to the target user. The technical solution of the present application improves the accuracy of determining logistics service schemes, which can enhance system performance.

These aspects of the present application, or other aspects, will be described more clearly in the following examples.

### BRIEF DESCRIPTION OF THE DRAWINGS

To more clearly illustrate the technical solutions in the embodiments of this application or the prior art, the following provides a brief introduction to the drawings used in the description of the embodiments or the prior art. It is evident that the drawings described below represent some embodiments of this application. For those skilled in the art, other drawings may also be obtained based on these drawings without creative effort.

FIG. 1 illustrates a schematic diagram of a system architecture where the technical solution of this application is applied.

FIG. 2 shows a flowchart of an embodiment of a method for determining a logistics service scheme provided by this application.

FIG. 3A illustrates a schematic display diagram of recommended information in a real-world application scenario according to an embodiment of this application.

FIG. 3B shows another schematic display diagram of recommended information in a real-world application scenario according to an embodiment of this application.

FIG. 4 presents a flowchart of an embodiment of a configuration method provided by this application.

FIG. 5A to FIG. 5C respectively illustrate schematic interface display diagrams of an embodiment of this application in a real-world application.

FIG. 6 shows a schematic diagram of scene interaction in a real-world application scenario according to an embodiment of this application.

FIG. 7 presents a schematic structural diagram of an embodiment of a logistics service scheme determination device provided by this application.

FIG. 8 illustrates a schematic structural diagram of an embodiment of a configuration device provided by this application.

FIG. 9 presents a schematic structural diagram of an embodiment of a computing device provided by this application.

### DETAIL DESCRIPTION OF THE EMBODIMENTS

In order to help those skilled in the art better understand the solution of this application, the following will describe the technical solution in the embodiments of this application in a clear and complete manner, with reference to the accompanying drawings in the embodiments of this application.

In some processes described in the specification, claims, and the aforementioned drawings of this application, a plurality of operations appear in a specific sequence. However, it should be clearly understood that these operations may be executed in an order different from their appearance in this document or executed in parallel. The operation sequence numbers, such as 101, 102, etc., are merely used to distinguish different operations and do not indicate any execution order. Additionally, these processes may include more or fewer operations, and the operations may be executed sequentially or in parallel. It should be noted that the terms “first,” “second,” etc., used herein are only for distinguishing different messages, devices, modules, etc., and do not represent a sequential order, nor do they imply that “first” and “second” are of different types.

The technical solution of the embodiments of this application can be applied to various logistics service scenarios, such as cross-border logistics service scenarios. At present, many logistics service providers can offer logistics service schemes and carry out object transportation according to these solutions.

In practical applications, the object demander and the object provider can interact through offline or online means to reach a consensus on object exchange. Consequently, they can entrust a logistics service provider to transport the object to its destination according to the provided logistics service scheme. For example, in the electronic transaction scenario of object exchange described in the background technology, the object exchanged using resources by the customer (such as goods purchased with cash in an e-commerce scenario) needs to be transported to the destination. This is achieved by the object provider entrusting a logistics service provider to implement the logistics service scheme.

Since there are many logistics service providers, and each provider can offer a plurality of logistics service schemes, the selection of a suitable plan is crucial. Currently, users typically choose a logistics service scheme manually or rely on a system-default option. However, the chosen plan may not always meet user requirements accurately. In such cases, additional online interactions between the object demander and the object provider may be necessary to finalize the logistics details. This increases system computational load and affects overall system performance.

To improve the accuracy of logistics service scheme selection and reduce the impact on system performance, the inventors have proposed the technical solution of this application after a series of studies. Through the recommendation rules in the embodiments of this application, a plurality of logistics service schemes can be evaluated based on their matching degree with the target user. By determining the matching degree of each logistics service scheme with the target user, at least one target logistics service scheme can be identified and recommended to the user. By calculating the matching degree, personalized logistics service schemes can be determined for the target user, ensuring that the selected plan better meets user requirements. This approach enhances the accuracy of logistics service scheme selection, reduces the number of online interactions, and improves system performance.

The technical solutions in the embodiments of this application will be clearly and comprehensively described below in conjunction with the accompanying drawings. It is evident that the described embodiments are only a part of the possible implementations of this application, rather than all of them. Based on the embodiments in this application, any other implementations obtained by those skilled in the art without requiring inventive effort shall also fall within the scope of protection of this application.

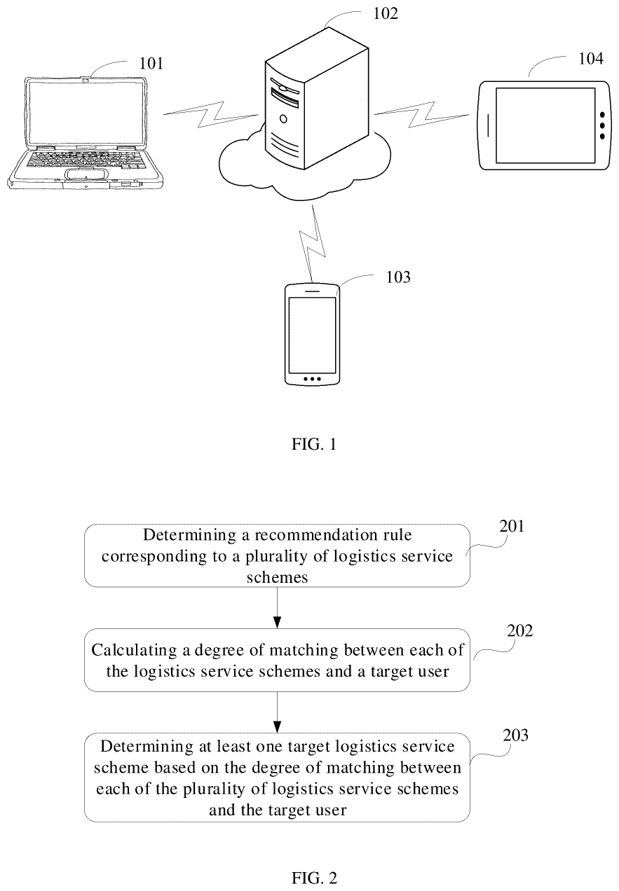

FIG. 1 illustrates a system architecture diagram in which a technical solution of an embodiment of this application can be applied. This system architecture may include a configuration terminal 101 and a server 102.

Additionally, the system architecture may further include a user terminal 103 and a service provider client 104 corresponding to the logistics service provider, among others.

In one implementation, the configuration terminal 101 and the server 102 can be independent of each other, deployed on different devices, and connected via a network. The network serves as a communication medium between the configuration terminal 101, user terminal 103, service provider client 104, and server 102. The network may include various connection types, such as wired, wireless communication links, or fiber optic cables. Optionally, the server can establish a communication connection with the configuration terminal via a mobile network. Correspondingly, the mobile network standard may be any of 2G (GSM), 2.5G (GPRS), 3G (WCDMA, TD-SCDMA, CDMA2000, UMTS), 4G (LTE), 4G+ (LTE+), 5G, WiMax, etc.

In this implementation, the configuration terminal 101, user terminal 103, and service provider client 104 can be implemented as a browser, app, web application such as an H5 (HyperText Markup Language 5) application, lightweight application (also known as a mini-program, a lightweight application), or cloud application. The configuration terminal 101 can be deployed on a device, requiring the device's operation or relying on certain apps within the device to function. The device can have a display screen and support information browsing, such as personal mobile terminals (e.g., smartphones, tablets), personal computers, desktop computers, smart speakers, smartwatches, etc. For case of understanding, FIG. 1 primarily represents the configuration terminal in the form of a device. Various other types of applications may also be installed on the device, such as human-computer interaction applications, model training applications, text processing applications, web browsers, shopping applications, search applications, instant messaging tools, email clients, social media platforms, etc. Devices typically include at least one processing component and at least one storage component. Electronic devices may also include network card chips, I/O buses, audio-video components, etc., but this application does not impose any limitations on such configurations. Optionally, depending on the implementation form of the electronic device, it may also include peripheral devices such as keyboards, mice, styluses, printers, etc., but this application does not impose any restrictions on them.

Additionally, in another implementation, the configuration terminal 101 and the server 102 can be integrated into the same device. In this case, the configuration terminal 101 can serve as the interactive interface between the server 102 and the user. For example, it can function as the user interface provided by the server 102, enabling it to perceive and respond to user operations.

It should be noted that the server 102 can be implemented as a distributed server cluster composed of a plurality of servers or as a single server. The server can also be a server within a distributed system or a server integrated with blockchain technology. Additionally, the server can function as a cloud server providing various cloud computing services, such as: cloud services, cloud databases, cloud computing, cloud functions, cloud storage, network services, cloud communication, middleware services, domain name services, security services, content delivery network (CDN), big data and artificial intelligence platforms. Moreover, the server can also be an intelligent cloud computing server or an intelligent cloud host with integrated artificial intelligence technologies.

In the context of electronic transactions involving object exchange, the aforementioned system architecture serves as an online exchange system for facilitating object exchange. Of course, it can also be a logistics service system that either operates independently or in association with the online exchange system to support logistics service transactions. This application does not impose any limitations in this regard.

It should be noted that the configuration method provided in the embodiments of this application is generally executed by the server 102, and the corresponding configuration device is typically set up within the server 102. However, in other embodiments of this application, the configuration terminal 101 may also have similar functionalities as the server 102, enabling it to execute the configuration method provided in this application. In other implementations, the configuration method may also be jointly executed by the configuration terminal 101 and the server 102. Similarly, the logistics service scheme determination method provided in this application is generally executed by the server 102, with the corresponding logistics service scheme determination device also set up within the server 102.

It should be noted that the technical solutions provided in this application are applicable in a network virtual environment. The user described herein generally refers to a “virtual user”, and a real user can register an account on the server to obtain a user identity within the network environment, among other things.

It should be noted that the embodiments of this application may involve the use of user data. In practical applications, user-specific personal data can be used within the solutions described herein, provided that such use complies with the applicable laws and regulations of the respective country (for example, obtaining explicit user consent, providing clear user notification, etc.) and is within the scope permitted by applicable laws and regulations.

The following provides a detailed description of the implementation details of the technical solutions in the embodiments of this application.

FIG. 2 is a flowchart of one embodiment of a logistics service scheme determination method provided in the embodiments of this application. The technical solution of this embodiment is executed by a server and may include the following steps:

S201: determining a recommendation rule corresponding to a plurality of logistics service schemes.

The recommendation rule is generated based on at least one evaluation rule corresponding to at least one evaluation factor and the constraint relationships between the at least one evaluation rules. Each evaluation factor corresponds to at least one evaluation rule, and there may be at least one constraint relationship among the evaluation rules corresponding to each evaluation factor. The specific implementation of the recommendation rules will be described in detail in the following embodiments.

The plurality of logistics service schemes may include all logistics service schemes provided by different logistics service providers. Additionally, to improve computational efficiency, optionally, a plurality of logistics service schemes that match the target user's characteristics can be determined based on the target user's feature data. In other words, a plurality of logistics service schemes can first be filtered and obtained based on the user's feature data.

The plurality of logistics service schemes may correspond to the same recommendation rule, meaning that the recommendation rule is generalizable and can be applied to all logistics service schemes. Additionally, to further improve the accuracy of logistics service scheme determination, different types of logistics services may correspond to different recommendation rules. Since logistics service scenarios are often complex and typically involve various types of logistics services—especially in cross-border logistics scenarios—different types of logistics services may include, for example, full-container sea freight, less-than-container-load (LCL) sea freight, air freight, express delivery, and so on. Therefore, optionally, determining the recommendation rules corresponding to a plurality of logistics service schemes may include: determining a plurality of logistics service schemes matching the target user based on the target user's feature data; and determining the recommendation rules corresponding to the plurality of logistics service schemes based on the types of logistics services associated with each logistics service scheme.

Different logistics service types, as well as the same logistics service type, may include a plurality of pre-configured recommendation rules. These rules can be selected from a set of active recommendation rules to determine the recommendation rules corresponding to a plurality of logistics service schemes.

Of course, the plurality of logistics service schemes may correspond to the same logistics service type, in order to determine the target logistics service scheme to recommend for a specific logistics service type.

In this context, “full-container sea freight” refers to a scenario where only one consignor ships a full container of goods to the destination port. “Less-than-container-load (LCL) sea freight” refers to the process of consolidating goods with the same destination and nature from a plurality of consignors into the same container for transportation. LCL sea freight involves goods from a plurality of consignors and consignees. The demand side refers to the consignee, while the supply side refers to the consignor. The goods provided by the consignor are transported as the cargo.

In the embodiments of this application, a logistics service scheme may include a plurality of attribute factors such as origin location, destination location, logistics service provider, logistics route, transportation cost, transportation time efficiency, and logistics carrier. The attribute factors included in a logistics service scheme may vary depending on different practical application scenarios, and this application does not impose limitations on this. For different types of logistics services, for example: in sea freight, the origin location refers to the port of departure, and the destination location refers to the port of arrival; in air freight, the origin location refers to the departure airport, and the destination location refers to the arrival airport; in express delivery, the origin location refers to the sender's address, and the destination location refers to the recipient's address. The logistics route refers to the transportation path. When the logistics service provider is a freight forwarder, it may cooperate with a plurality of logistics carriers, as the carriers are responsible for the actual transportation tasks.

Each logistics service provider specifically offers logistics services for transporting goods in accordance with the attribute factors included in the logistics service scheme.

The user feature data may include user profile data determined based on user behavior, historical logistics service orders, user attributes, and more. The user profile data may include, for example, the user's preferred origin and destination locations, logistics service providers, price ranges, transportation timeframes, and so on. This user profile data can be obtained through statistical data analysis or similar methods, and this application does not impose limitations on how it is determined.

Therefore, optionally, determining a plurality of logistics service schemes that match the target user based on the user's feature data may include:
determining the user's preferred origin location, destination location, logistics service provider, price range, and/or transportation time range based on the target user's profile data; and identifying a plurality of logistics service schemes that satisfy one or more of the following matching conditions. These matching conditions may include:
service coverage matching the origin or destination location, inclusion of the preferred logistics service provider, transportation price falling within the preferred price range, and transportation time falling within the preferred timeframe.

Matching the service coverage with the user's preferred origin or destination location may, for example, mean that at least one of the following conditions is satisfied: the origin location of the logistics service scheme is the same as the user's preferred origin location; the origin location is a nearby location to the preferred origin; the destination location is the same as the user's preferred destination location; or the destination location is a nearby location to the preferred destination. If any of these conditions are met, the service coverage is considered to match the user's preferred origin or destination location.

The nearby location of the user's preferred origin location may refer to a location adjacent to the preferred origin, a location within the same service area, or a location associated with the preferred origin. For example, if the origin is a departure port, the nearby location may refer to a port in the same city as the user's preferred departure port or an associated port.

Similarly, the nearby location of the user's preferred destination location may refer to a location adjacent to the preferred destination, a location within the same service area, or a location associated with the preferred destination. For example, if the destination is a destination port, the nearby location may refer to a port in the same city as the user's preferred destination port or an associated port.

S202: calculating a degree of matching between each of the logistics service schemes and a target user based on attribute data of the at least one evaluation factor respectively corresponding to the plurality of logistics service schemes, according to the at least one evaluation rule respectively corresponding to the at least one evaluation factor and the constraint relationship among the at least one evaluation rule.

Among them, at least one evaluation factor in the recommendation rules refers to an attribute factor of the logistics service scheme, which may be selected from among the plurality of attribute factors of the logistics service scheme. Each evaluation rule corresponding to an evaluation factor is used to assess the degree of matching between the logistics service scheme and the target user from the perspective of that evaluation factor. Specifically, it can be used to calculate a matching score between the logistics service scheme and the target user. Constraint relationships can be applied to integrate the matching scores of the evaluation rules under those constraints to obtain an evaluation score. By integrating the evaluation scores of at least one evaluation factor, a total evaluation score can be obtained, which serves as the overall degree of matching. The higher the matching degree, the better the logistics service scheme aligns with the target user's needs. Typically, a higher total evaluation score indicates a higher degree of matching. However, depending on the score determination method used, a lower total score may also indicate a higher matching degree. This application does not impose any limitations on such implementations.

For each evaluation rule under each evaluation factor, the calculated matching score between the logistics service scheme and the target user can be obtained based on the attribute data of the logistics service scheme corresponding to that evaluation factor. Optionally, in some cases, the matching score may also be calculated based on both the attribute data of the logistics service scheme for that evaluation factor and the target user's historical preference data related to that evaluation factor.

Each evaluation factor may correspond to one or more evaluation rules, and these rules can have one or more constraint relationships. The evaluation rules may be divided into a plurality of groups, where constraint relationships can be defined both within each group and between different groups. These constraint relationships may include, for example, additive relationships or mutually exclusive relationships. For evaluation rules within the same group that have an additive relationship, the matching scores corresponding to each evaluation rule can be summed to serve as the matching score for that group. For evaluation rules with a mutually exclusive relationship, the matching score of any one rule may be selected as the group's matching score. Optionally, the matching score of the rule with the highest priority may be chosen. The priority can be predefined or determined based on the order in which the evaluation rules were configured-rules configured earlier have higher priority, while those configured later have lower priority. For groups with an additive relationship, their respective group matching scores can be summed to derive the evaluation score for the corresponding evaluation factor. For groups with a mutually exclusive relationship, the matching score of any one group may be selected as the evaluation score for the evaluation factor. Optionally, the matching score of the group with the highest priority may be used. Again, priority may be predefined or determined by the configuration order—groups configured earlier have higher priority than those configured later.

S203: determining at least one target logistics service scheme based on the degree of matching between each of the plurality of logistics service schemes and the target user.

The at least one target logistics service scheme is intended to be recommended to the target user.

Optionally, the logistics service scheme with the highest matching degree may be selected as the target scheme for recommendation to the target user. Alternatively, a plurality of logistics service schemes can be selected in descending order of their matching degree and recommended to the target user, allowing the user to choose the most suitable logistics service scheme from a plurality of recommended options.

Through the technical solution of the above embodiment, the recommendation rules incorporate a two-layer logic including evaluation factors and evaluation rules, enabling accurate calculation of the degree of matching. As a result, the at least one determined target logistics service scheme is more accurate and better meets user requirements, allowing for personalized recommendations. This, in turn, improves the accuracy of logistics service scheme determination and can reduce the number of online interactions, thereby enhancing system performance.

In some embodiments, the process of calculating the degree of matching between a logistics service scheme and the target user—based on the attribute data corresponding to at least one evaluation factor of the logistics service scheme, and in accordance with at least one evaluation rule corresponding to each evaluation factor and the associated constraint relationships—may include:
for any given logistics service scheme, determining the attribute data corresponding to at least one evaluation factor in the recommendation rules associated with the scheme;
based on the attribute data of the logistics service scheme for a given evaluation factor, calculating the matching score corresponding to a given evaluation rule for that evaluation factor;
according to the constraint relationships among the one or more evaluation rules corresponding to the evaluation factor, integrating the respective matching scores to obtain the evaluation score for that factor;
integrating the evaluation scores corresponding to the one or more evaluation factors to obtain the total evaluation score for the logistics service scheme;
using the total evaluation score as the degree of matching between the logistics service scheme and the target user.

The evaluation factors may include, for example, the origin port. The attribute data of the logistics service scheme corresponding to this evaluation factor may be a specific port name, such as “Port A”. Another evaluation factor may be the transportation price, where the corresponding attribute data could be a specific price value, such as “USD 100”. Yet another evaluation factor may include feature tags, with corresponding attribute data such as specific tag names like “Limited-Time Offer” or “Special Price”. Additional examples are not listed herein.

The evaluation rules are used to calculate the matching score from the perspective of each evaluation factor. The evaluation score obtained by integrating the matching scores from different evaluation rules corresponding to the evaluation factor represents the degree of matching between the logistics service scheme and the target user with respect to that evaluation factor.

As described above, the constraint relationships may include additive relationships, mutually exclusive relationships, and so on. The evaluation rules corresponding to an evaluation factor may be divided into a plurality of groups, and constraint relationships may also exist between different groups. To facilitate understanding of the process of integrating the matching scores corresponding to the evaluation rules of an evaluation factor, consider the following example: suppose evaluation factor A corresponds to two groups of evaluation rules—a first group and a second group. The first group contains three evaluation rules, and the second group contains one evaluation rule. The three evaluation rules in the first group are in an additive relationship, while the first and second groups have a mutually exclusive relationship. Thus, the matching score for the first group is obtained by adding together the matching scores corresponding to its three evaluation rules. The matching score for the second group is simply the matching score corresponding to its single evaluation rule. If the first group of evaluation rules has a higher priority than the second group, then, according to the mutually exclusive relationship, the matching score of the first group (with the highest priority) is used as the evaluation score for evaluation factor A. It should be noted that this example is provided solely for illustrative purposes, and the actual implementation may be more complex. No specific limitations are imposed by this application.

It should be noted that the matching score corresponding to an evaluation rule may be null. In such a case, the priority of the evaluation rule with a null matching score may be adjusted to the lowest level accordingly.

At least one constraint relationship may exist between evaluation factors. Such a constraint relationship may be pre-configured or flexibly defined by the user. In a practical application, the constraint relationship between at least one evaluation factor may be an additive relationship. In some embodiments, the evaluation scores corresponding to at least one evaluation factor are subjected to a fusion process. The total evaluation score corresponding to the logistics service scheme may be obtained by adding the evaluation scores of at least one evaluation factor.

The evaluation rules include a score determination method corresponding to the condition when the evaluation rule is satisfied. Optionally, the recommendation rules may include a total weighted score corresponding to each evaluation factor. The total weighted score is used to constrain the evaluation score obtained through computation such that it does not exceed the total weighted score. If the evaluation score calculated for any evaluation factor exceeds its corresponding total weighted score, the total weighted score shall be used as the evaluation score for that evaluation factor.

The score determination method may specifically refer to the proportional allocation of the total weighted score corresponding to each evaluation factor. The sum of the proportional allocations corresponding to different evaluation rules associated with a given evaluation factor shall not exceed 100%.

In some embodiments, at least one evaluation rule corresponding to any evaluation factor may include one or more of the following, which are provided for illustrative purposes only and are not intended to limit the scope of the present application:

(1): a score determination method based on the attribute preference data of the target user corresponding to an evaluation factor and the attribute data of the same evaluation factor in the current logistics service scheme, wherein different scores are assigned depending on the degree of similarity between the two sets of data.

The attribute preference data may be obtained by performing statistical analysis on historical logistics service schemes used by the target user. For example, it may refer to historical attribute data involved in logistics service schemes used within the past 30 days.

The current logistics service scheme refers to any logistics service scheme to be matched.

Different similarity conditions may refer to varying degrees of similarity between the attribute preference data and the attribute data of the logistics service scheme.

Taking the evaluation factor “origin port” as an example, the attribute preference data refers to the origin ports involved in the historical logistics service schemes used within the past 30 days. The attribute data of the logistics service scheme corresponding to this evaluation factor is “Port A.” Different similarity conditions may include, for example: if the origin ports involved in the target user's historical logistics service schemes within the past 30 days include “Port A,” the corresponding score determination method may be 100% of the total weighted score; if the origin ports include a co-located port (in the same city as “Port A”), the corresponding score determination method may be 90% of the total weighted score; if the origin ports include an associated port of “Port A,” the corresponding score determination method may be 80% of the total weighted score, and so on.

As another example, the evaluation factor may be transportation cost, and the attribute preference data may represent the user's preferred price. Different similarity conditions may include varying differences between the transportation cost of the logistics service scheme and the user's preferred price. If the difference is less than a first threshold value, the corresponding score determination method may be 100% of the total weighted score. If the difference is greater than the first threshold value but less than a second threshold value, the corresponding score determination method may be 80% of the total weighted score. If the difference exceeds the second threshold value, the corresponding score determination method may be 50% of the total weighted score, and so forth.

(2): a score determination method corresponding to the presence of predefined labels in the current logistics service scheme.

For example, if the current logistics service scheme includes a predefined label “Label A,” the corresponding score determination method may be 20% of the total weighted score.

(3): a score determination method based on the ranking position of the attribute data of the current logistics service scheme among a plurality of logistics service schemes.

For example, if the evaluation factor is transportation cost, the logistics service schemes may be ranked in ascending order based on their cost values. The corresponding score determination method may involve deducting 10% of the total weighted score for each position the scheme drops in the ranking. Assuming the scheme is ranked second, the matching score would be 80% of the total weighted score.

(4): a score determination method based on the attribute data of the effective time of the current logistics service scheme, wherein different scores are assigned depending on the time difference between the effective time and the current time falling within different time ranges.

For example, if the evaluation factor is the fulfillment date, and the difference between the fulfillment date and the current date is within the range of 0 to 7 days, the score determination method may be 80% of the total weighted score. If the difference exceeds 7 days, the score determination method may be 20% of the total weighted score, and so forth.

Based on the possible implementation methods of the above evaluation rules, in some embodiments, calculating the matching score corresponding to any evaluation rule for the attribute data of any evaluation factor of the logistics service scheme may include:
determining the corresponding matching score based on the attribute data of any evaluation factor of the logistics service scheme, and the score determination method corresponding to the similarity condition between the attribute preference data of the target user and the attribute data;
determining the corresponding matching score according to the score determination method corresponding to at least one label included in the logistics service scheme;
determining the corresponding matching score based on the attribute data of any evaluation factor of the logistics service scheme and the score determination method corresponding to its ranking position among a plurality of logistics service schemes;
or,
determining the corresponding matching score based on the attribute data of any evaluation factor of the logistics service scheme and the score determination method corresponding to the time range in which the difference between the effective time and the current time falls.

In some embodiments, determining the recommendation rules corresponding to a plurality of logistics service schemes may include: in response to a service recommendation task, determining the recommendation rules corresponding to a plurality of logistics service schemes.

The service recommendation task may include a logistics service type and may further include user characteristic data. Accordingly, a plurality of logistics service schemes corresponding to the logistics service type, as well as the recommendation rules associated with the logistics service type, can be determined based on the user characteristic data.

The service recommendation task may be implemented in various ways. Therefore, in some embodiments, the method may further include:
generating a service recommendation task based on a service recommendation request sent by the target user; generating a service recommendation task when the target user performs a target action; or generating a service recommendation task in response to detecting a target event.

The service recommendation request may be actively triggered by the target user. For example, in an electronic transaction scenario, the target user may be the provider of an object. After the demand-side user places an order for the object, an exchange order is generated. The object provider may then initiate a service recommendation request based on the exchange order;
the target action may be a predefined user behavior. For example, it may be a logistics service scheme search behavior—i.e., when the target user searches for logistics service schemes, a service recommendation task may be generated, and at least one identified target logistics service scheme may be provided to the target user as a search result.

The target event may be a predefined event. For example, the target event may be periodically generated and sent to the server by a control system, or it may be generated by the server in response to an order request for the object submitted by the demand-side user. In this way, a service recommendation task can be generated simultaneously with the creation of the exchange order, enabling the recommendation of at least one target logistics service scheme to either the demand-side user or the object provider.

In some embodiments, the recommendation rules may also include a recommendation method. In such cases, the method may further include:
recommending at least one target logistics service scheme to the target user according to the recommendation method specified in the recommendation rules.

The recommendation method may include, for example, email notification, instant message notification, or page display, and may further include offline notification, manual outbound calling, or intelligent outbound calling.

For example, the email notification method may specifically involve sending the recommendation information of at least one target logistics service to the target user's email account;
for the instant message notification method, it may specifically involve sending the recommendation information of at least one target logistics service to the target user's instant messaging account;
for the offline notification method, it may involve notifying relevant personnel of the at least one target logistics service scheme associated with the target user, so that they can inform the user through an offline visit;
for the manual outbound calling method, it may involve relevant personnel informing the target user of the at least one target logistics service scheme by placing a phone call;
for the intelligent outbound calling method, it may involve automatically controlling related devices to inform the target user of the at least one target logistics service scheme by phone call;
for the page display method, it may involve displaying the recommendation information of at least one target logistics service on a designated page. The designated page may be, for example, an object order page, a search results page, or a logistics service promotion page, but is not limited thereto. It may also involve sending the recommendation information of at least one target logistics service to the user terminal associated with the target user, so that the information is displayed on the target page at the user terminal.

In some embodiments, the method may further include:
determining at least one recommendation field in the recommendation rules; generating recommendation information based on the field data corresponding to at least one recommendation field of any given target logistics service scheme; and sending the respective recommendation information of at least one target logistics service scheme to the target user.

Optionally, the respective recommendation information of at least one target logistics service scheme may be sent to the target user in accordance with the recommendation method specified in the recommendation rules.

The at least one recommendation field may include, for example, the origin location, destination location, transportation price, and/or transit time. The recommendation information may be, for example: “We recommend a shipment from Yantian Port, China to Los Angeles, USA, with a scheduled departure on [XX Month XX Day], transit time: 25 days, price as low as: 3000 RMB.”

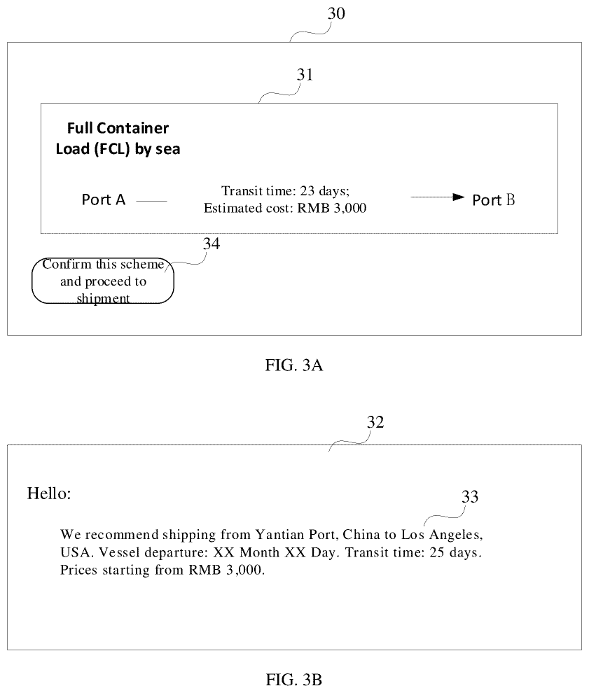

To facilitate understanding, for example, FIG. 3A illustrates a schematic diagram showing the display of recommendation information 31 on a target page 30, and FIG. 3B illustrates a schematic diagram showing the display of recommendation information 33 in email content 32.

In some embodiments, the method may further include:
receiving a logistics service request sent by the target user for any target logistics service scheme; generating a logistics service order; and sending the logistics service order to the logistics service provider corresponding to the target logistics service scheme.

For example, when the recommendation information of a target logistics service scheme is displayed on the target page, the target user may also trigger a logistics service request for that scheme—for instance, by interacting with an order-triggering control displayed on the target page, such as the order-triggering control 34 shown in FIG. 3A. This interaction triggers the logistics service request, which can then be used to generate a logistics service order.

The logistics service order may be sent to the target logistics service provider corresponding to the target logistics service scheme, so that the provider can deliver the logistics transportation service according to the order.

Optionally, the logistics service order may be sent to a service provider client corresponding to the target logistics service provider, so that the client can output a prompt related to the order—for example, by displaying the logistics service order or playing a corresponding audio notification.

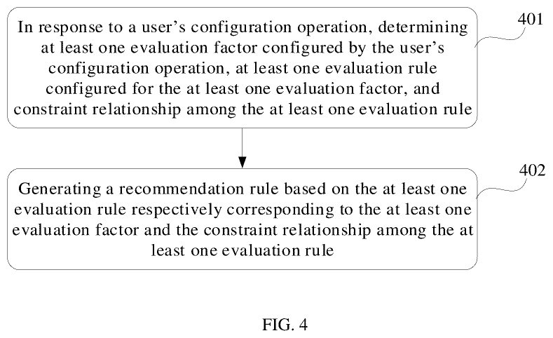

The recommendation rules involved in the above embodiments may be pre-configured by configuration personnel, allowing for flexible setup and updates based on actual needs. As shown in FIG. 4, which illustrates a flowchart of one embodiment of a configuration method provided by this application, the method may be executed by a configuration terminal or on the server. The method may include the following steps:

S401: in response to a user's configuration operation, determining at least one evaluation factor configured by the user's confirmation operation, at least one evaluation rule configured for the at least one evaluation factor, and constraint relationship among the at least one evaluation rule.

The user's configuration operation may be triggered by a configuration personnel. For each evaluation factor, at least one corresponding evaluation rule and the constraint relationships among the evaluation rules may be configured.

As an optional approach, the user's configuration operation may include configuration code input by the user, based on which the configured evaluation factors, evaluation rules, and constraint relationships can be determined.

Additionally, as another optional approach, to facilitate the configuration process, a configuration interface and corresponding configuration prompts may be provided to the configuration personnel, making it easier for them to perform the user's configuration operation.

The evaluation factors, evaluation rules, and constraint relationships have been described in detail in the preceding embodiments and will not be repeated here.

S402: generating a recommendation rule based on the at least one evaluation rule respectively corresponding to the at least one evaluation factor and the constraint relationship among the at least one evaluation rule.

The recommendation rules are used to determine the degree of matching between the target user and each of a plurality of logistics service schemes, in order to identify at least one target logistics service scheme to be recommended to the target user based on the degree of matching.

The specific implementation of calculating the degree of matching based on the recommendation rules has been described in detail in the relevant preceding embodiments and will not be repeated here.

In the case where the technical solution of this embodiment is executed by the configuration terminal, the recommendation rules may be sent to the server, so that the server can execute the logistics service scheme determination method as illustrated in the embodiment shown in FIG. 2.

In some embodiments, complex recommendation rules are implemented through a configurable approach, enabling flexible configuration of the rules. The recommendation rules adopt a two-layer logic structure comprising evaluation factors and evaluation rules, enabling accurate calculation of the degree of matching. Therefore, based on the configured recommendation rules, it is possible to accurately determine the degree of matching between the target user and each of the plurality of logistics service schemes, and to identify at least one target logistics service scheme to be recommended to the user accordingly. The determined target logistics service scheme(s) are more accurate and better meet user requirements, thereby enabling personalized recommendations. This improves the accuracy of determining logistics service schemes, reduces the number of online interactions, and enhances system performance.

In some embodiments, the method may further include: determining the configured recommendation method in response to a user's configuration operation.

The step of generating recommendation rules based on at least one evaluation rule corresponding to each evaluation factor and the constraint relationships among the evaluation rules may include:
generating the recommendation rules based on the evaluation rules corresponding to the evaluation factors, the constraint relationships among the evaluation rules, and the recommendation method.

The recommendation method is used to indicate how the target logistics service scheme should be recommended to the target user.

In some embodiments, the method may further include: determining at least one configured recommendation field in response to a user's configuration operation;
the step of generating recommendation rules based on at least one evaluation rule corresponding to each evaluation factor and the constraint relationships among the evaluation rules may include:
generating recommendation rules based on the evaluation rules corresponding to each evaluation factor, the constraint relationships among the evaluation rules, and at least one recommendation field.
each target logistics service scheme corresponds to at least one piece of field data from the recommendation field(s), which is used to generate the recommendation information corresponding to that logistics service scheme.

In some embodiments, the method may further include: determining the configured logistics service type in response to a user's configuration operation;
the step of generating recommendation rules based on at least one evaluation rule corresponding to each evaluation factor and the constraint relationships among the evaluation rules may include:
generating recommendation rules corresponding to the logistics service type based on the evaluation rules corresponding to each evaluation factor and the constraint relationships among the evaluation rules.

Of course, in some embodiments, the method may also include at least one of the following operations: determining the configured recommendation method in response to a user's configuration operation; determining at least one configured recommendation field in response to a user's configuration operation; and determining the configured logistics service type in response to a user's configuration operation;
the method may further include: determining the configured recommendation method, at least one recommendation field, and logistics service type in response to a user's configuration operation;
the step of generating recommendation rules based on at least one evaluation rule corresponding to each evaluation factor and the constraint relationships among the evaluation rules may include:
generating recommendation rules based on the evaluation rules corresponding to each evaluation factor and the constraint relationships among the evaluation rules, in combination with at least one of the recommendation method, at least one recommendation field, and the logistics service type.

As described above, a configuration interface may be provided to configuration personnel to perform the user's configuration operation. Therefore, in some embodiments, determining at least one configured evaluation factor, at least one evaluation rule configured for any given evaluation factor, and the constraint relationships among the evaluation rules in response to a user's configuration operation may include:
providing a configuration interface;
providing evaluation factor configuration controls on the configuration interface;
determining the configured evaluation factor(s) in response to configuration operations performed on the evaluation factor configuration controls;
providing rule configuration controls corresponding to each evaluation factor on the configuration interface;
determining the configured evaluation rule(s) and the constraint relationship(s) among the evaluation rules in response to configuration operations performed on the rule configuration controls corresponding to any evaluation factor.

The evaluation factor configuration controls may provide options corresponding to a plurality of attribute factors, from which the configuration personnel can select at least one evaluation factor.

In some embodiments, the rule configuration controls may include: a relationship configuration control, a type configuration control, a content configuration control, and a score configuration control.

Determining at least one evaluation rule and the constraint relationship(s) among the evaluation rules in response to configuration operations performed on the rule configuration controls corresponding to any evaluation factor may include:
providing a relationship configuration prompt on the configuration interface;
displaying the relationship configuration control on the configuration interface in response to a trigger operation on the relationship configuration prompt;
determining the configured constraint relationship in response to a configuration operation on the relationship configuration control;
providing a rule configuration prompt on the configuration interface;
displaying the type configuration control, content configuration control, and score configuration control corresponding to the constraint relationship on the configuration interface in response to a trigger operation on the rule configuration prompt;
determining the configured rule type in response to a configuration operation on the type configuration control;
determining the configured rule content in response to a configuration operation on the content configuration control;
determining the score determination method in response to a configuration operation on the score configuration control;
generating an evaluation rule based on the rule type, rule content, and score determination method;
determining one or more evaluation rules configured under the constraint relationship.

In some embodiments, the evaluation factor configuration controls may include evaluation factor configuration sub-controls and total score configuration sub-controls. Determining at least one evaluation factor in response to a configuration operation performed on the evaluation factor configuration controls may include:

determining at least one evaluation factor in response to a configuration operation performed on the evaluation factor configuration sub-controls;
determining the corresponding total weight score in response to a configuration operation performed on the total score configuration sub-control corresponding to any evaluation factor.

The score determination method for any evaluation rule may refer to the proportion of the total weight score.

The type configuration control is used to configure the rule type, the content configuration control is used to configure the rule content, and the score configuration control is used to configure the score determination method. Examples of rule types include “scoring based on meeting conditions,” “scoring based on inclusion,” “scoring based on the difference from the current date,” or “penalizing scores based on ascending sorting,” among others. For example: for the rule type “scoring based on meeting conditions,” the rule content may be “the historical logistics service provider over the past 30 days includes the departure port,” and the corresponding score determination method could be “30%.” For the rule type “scoring based on inclusion,” the rule content may involve including one or more preset “target tags,” with the corresponding score determination method being “20%.” For the rule type “scoring based on the difference from the current date,” the rule content could be “effective date” along with a plurality of “difference ranges,” with different score determination methods applied depending on the specific difference range. For the rule type “penalizing scores based on ascending sorting,” the rule content could be “transportation price,” with the score determination method being a 10% deduction for each rank decrease in sorting order. It should be noted that the above examples are provided merely for illustration purposes, and are not intended to limit the scope of the present application.

In some embodiments, the method may further include:
providing a field configuration control on the configuration interface; and
determining the configured at least one recommendation field in response to a user's configuration operation may include:
determining the configured at least one recommendation field in response to a configuration operation performed on the field configuration control.

In some embodiments, the method may further include:
providing a method configuration control on the configuration interface; and
determining the configured recommendation method in response to a user's configuration operation may include:
determining the configured recommendation method in response to a configuration operation performed on the method configuration control.

In some embodiments, the method may further include:
providing a service type configuration control on the configuration interface; and
determining the configured logistics service type in response to a user's configuration operation may include:
determining the configured logistics service type in response to a configuration operation performed on the service type configuration control.

In some embodiments, the method may further include one or more of the following operations:
providing a field configuration control on the configuration interface, and determining the configured at least one recommendation field in response to a configuration operation performed on the field configuration control;
providing a method configuration control on the configuration interface, and determining the configured recommendation method in response to a configuration operation performed on the method configuration control; and
providing a service type configuration control on the configuration interface, and determining the configured logistics service type in response to a configuration operation performed on the service type configuration control;
generating the recommendation rule based on at least one evaluation factor corresponding to at least one evaluation rule and the constraint relationships among the evaluation rules may involve: generating the recommendation rule based on at least one evaluation factor corresponding to at least one evaluation rule and the constraint relationships among the evaluation rules, combined with at least one of the recommendation method, the at least one recommendation field, and the logistics service type.

Additionally, in some embodiments, the configuration interface may further provide a rule identifier configuration control. A rule identifier may be determined in response to a trigger operation performed on the rule identifier configuration control. The rule identifier may include a scheme name and/or a scheme code, among others.

According to the technical solutions of the present application, the configuration personnel may configure a plurality of recommendation rules. A plurality of recommendation rules can be configured for different logistics service types, or even for the same logistics service type. To facilitate user review, in some embodiments, the method may further include:
displaying rule prompt information corresponding to a plurality of recommendation rules on the configuration interface.

The rule prompt information may include the logistics service type and the rule name corresponding to the recommendation rule.

Additionally, the rule prompt information may further include at least one operation control. In this case, the method may further include:
in response to a trigger operation performed on any operation control corresponding to a recommendation rule, processing the recommendation rule according to the corresponding operation type.

The at least one operation control may include, for example, a start control, a delete control, a view control, an edit control, and/or a test control.

For example, in response to a trigger operation performed on the start control of a recommendation rule, the recommendation rule may be switched to an active state. In this active state, the recommendation rule can be used to determine the degree of match between a target user and a plurality of logistics service schemes. After the start control is triggered, it may be updated to a stop control. Accordingly, in response to a trigger operation performed on the stop control, the recommendation rule may be switched to an inactive state.

For another example, in response to a trigger operation performed on the delete control of a recommendation rule, the corresponding recommendation rule may be deleted.

Similarly, in response to a trigger operation performed on the view control of a recommendation rule, at least one evaluation factor included in the recommendation rule, at least one evaluation rule corresponding to each evaluation factor, and the constraint relationships among the evaluation rules may be displayed.

For another example, in response to a trigger operation performed on the edit control of a recommendation rule, the configuration interface may redisplay the evaluation factor configuration control and the rule configuration control, allowing the recommendation rule to be edited again.

Likewise, in response to a trigger operation performed on the test control of a recommendation rule, a test operation may be triggered to execute the recommendation rule across a plurality of test scenarios.

Additionally, the rule prompt information may include status prompt information, which may indicate, for example, a running status, a testing status, or an inactive status.

Furthermore, the rule prompt information may also include identifiers of the configuration personnel and the configuration time.

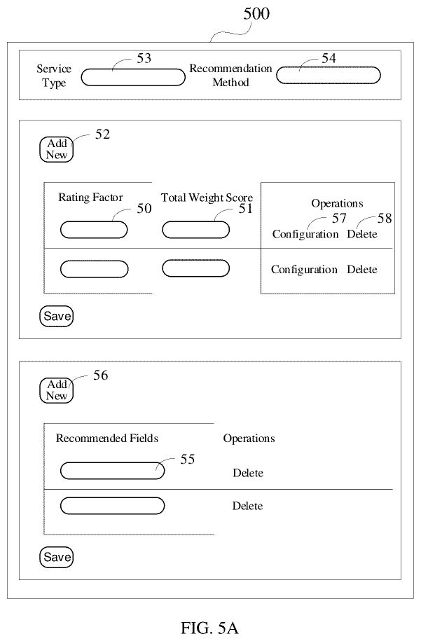

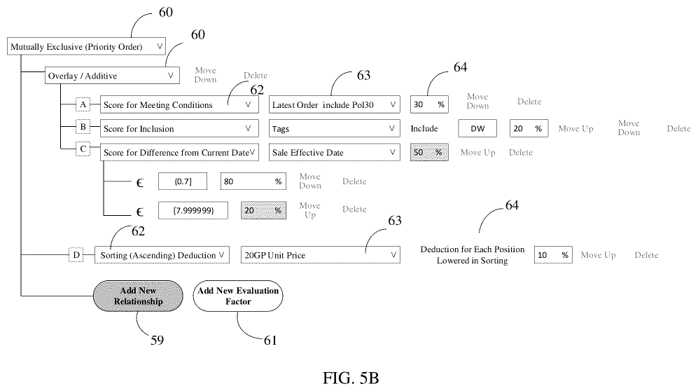

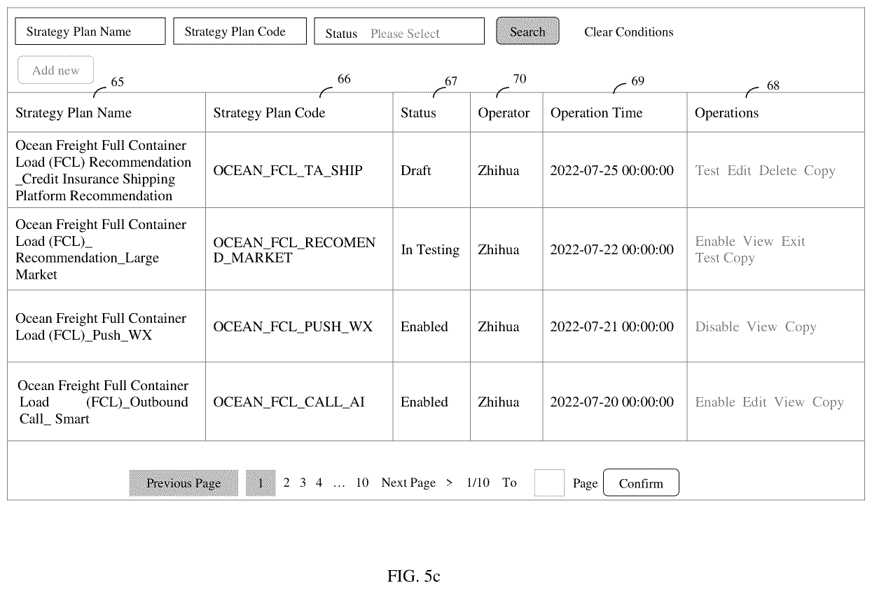

For better understanding, FIG. 5A to 5C respectively illustrate schematic diagrams of the configuration interface display. As shown in FIG. 5A, the configuration interface 500 may provide evaluation factor configuration controls, which may include an evaluation factor configuration sub-control 50 and a total score control 51. The configuration interface may display evaluation factor configuration prompt information 52. In response to a trigger operation on the prompt information 52, a new evaluation factor configuration control may be added to allow configuration personnel to configure evaluation factors.

Additionally, the configuration interface may also provide a service type configuration control 53, a recommendation method configuration control 54, and a field configuration control 55. The interface may display field configuration prompt information 56. In response to a trigger operation on the prompt information 56, a new field configuration control 55 may be added to allow configuration personnel to configure recommendation fields.

The configuration interface may further display operation prompt information 57 corresponding to each evaluation factor configuration control. In response to a trigger operation on the operation prompt information, a rule configuration control may be displayed on the configuration interface. Additionally, the configuration interface may display delete prompt information 58 for each evaluation factor configuration control. In response to a trigger operation on the delete prompt information, the corresponding configured evaluation factor may be deleted.

Optionally, in response to a trigger operation on the operation prompt information 57, the configuration interface may display the content shown in FIG. 5b. On the configuration interface shown in FIG. 5b, relationship configuration prompt information 59 may be displayed. In response to a trigger operation on the relationship configuration prompt information, a relationship configuration control 60 may be displayed on the configuration interface. Then, in response to a configuration operation on the relationship configuration control, the configured constraint relationship, such as a mutual exclusion relationship, may be determined.

Additionally, the configuration interface may also provide rule configuration prompt information 61. In response to a trigger operation on the rule configuration prompt information, the configuration interface may display controls for configuring the type 62, content 63, and score 64 of a constraint relationship. Each time the rule configuration prompt information is triggered, a new set of type configuration control 62, content configuration control 63, and score configuration control 64 may be added, allowing the configuration of a new evaluation rule. The rule type, rule content, and score determination method configured through a set of controls 62, 63, and 64 may form an evaluation rule. According to the above configuration method, one or more evaluation rules may be configured under a constraint relationship. The evaluation rules configured under the same constraint relationship are grouped together. Constraint relationships may also be configured between different groups of evaluation rules. As shown in FIG. 5B, evaluation rules A, B, and C have an additive relationship and form one group of evaluation rules. Evaluation rule D forms another group, and the two groups may be configured to have a mutual exclusion relationship. A priority order may also be set between them based on the configuration time.

As shown in the configuration interface of FIG. 5C, a plurality of rule prompt information corresponding to different recommendation rules are provided. The rule prompt information may include the rule name 65, rule code 66, status prompt information 67, and at least one operation control 68 corresponding to each recommendation rule. Additionally, it may also include the configuration time 69 and the configuration personnel information 70.

FIG. 5A to 5C are merely illustrative examples showing possible displays of the configuration interface. The present application is not limited thereto.

In a practical application, the technical solutions described in the embodiments of the present application may be applied to logistics service scenarios in cross-border e-commerce. In such a scenario, the target user may refer to the object provider, while the object demander is the customer. Through an online transaction system, the customer may purchase an object provided by the object provider. After generating a transaction order for the object, the object provider may trigger the selection of a logistics service scheme to place a logistics service order. To facilitate understanding of the technical solution proposed in this application, the following section introduces the technical solution using a cross-border e-commerce logistics service scenario, in combination with the interaction schematic shown in FIG. 5.

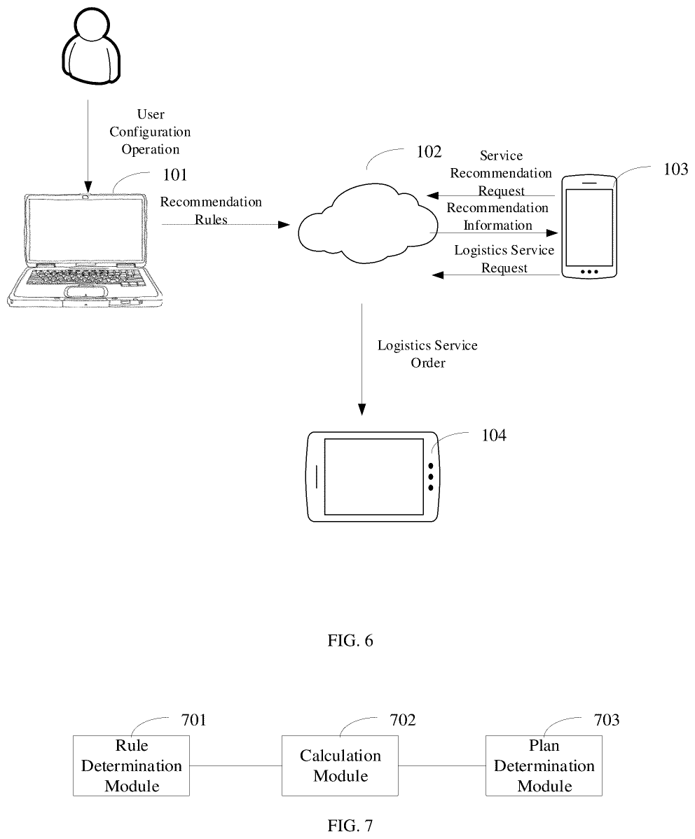

As shown in FIG. 6, the configuration end 101 may generate recommendation rules in response to user's configuration operations and send the recommendation rules to the server end 102. The server end 102 may be a cloud server, thereby leveraging cloud computing capabilities to efficiently perform configuration operations and determine logistics service schemes.

The object provider, for a particular transaction order, can trigger a service recommendation request via the user end 103. The server end 102, based on the user characteristic data of the object provider, determines a plurality of logistics service schemes. According to the recommendation rules corresponding to the logistics service schemes, the server determines the degree of match between each logistics service scheme and the object provider. The target logistics service scheme can be selected in descending order of the match degree between each logistics service scheme and the object provider. The recommended information for the target logistics service scheme is then generated and sent to the user end 103, where it is displayed.

The user end 103 may also respond to the object provider's selection operation of the target logistics service scheme by sending a corresponding logistics service request to the server end 102.

The server end 102 can generate a logistics service order for the target logistics service scheme based on the logistics service request. The server end 102 may then send the logistics service order to the service end client 104 corresponding to the target logistics service provider of the target logistics service scheme. The service end client 104 may display the logistics service order to notify the target logistics service provider to provide the transportation services corresponding to the target logistics service scheme.

FIG. 7 is a schematic structural diagram of an embodiment of a logistics service scheme determination device provided in the present application. The device may include:
a rule determination module 701, configured to determine the recommendation rules corresponding to a plurality of logistics service schemes. The recommendation rules are generated based on at least one evaluation factor, at least one evaluation rule corresponding to each evaluation factor, and the constraint relationships among the evaluation rules;
a calculation module 702, configured to calculate the degree of match between a logistics service scheme and a target user based on the attribute data corresponding to at least one evaluation factor of each logistics service scheme, in accordance with the corresponding evaluation rules and constraint relationships among the evaluation rules;
a plan determination module 703, configured to determine at least one target logistics service scheme based on the respective degrees of match between a plurality of logistics service schemes and the target user. The at least one target logistics service scheme is to be recommended to the target user.

In some embodiments, the rule determination module is specifically configured to determine a plurality of logistics service schemes that match the target user based on the user characteristic data of the target user; and to determine the recommendation rules corresponding to each of the logistics service schemes based on the respective logistics service types of the plurality of logistics service schemes.

In some embodiments, the user characteristic data includes user profile data. The plan determination module may specifically determine the user's preferred origin location, destination location, logistics service provider, price range, and/or transportation time range based on the target user's profile data. It then determines a plurality of logistics service schemes that satisfy one or more of the following matching conditions: the service coverage matches the origin or destination location; the plan includes the preferred logistics service provider; the transportation price falls within the preferred price range; and the transportation time falls within the preferred transportation time range.

In some embodiments, the device may further include:
a task generation module, configured to generate a service recommendation task based on a service recommendation request sent by the target user; generate a service recommendation task upon the occurrence of a target behavior by the target user; or generate a service recommendation task upon detecting a target event;
the rule determination module may specifically determine the recommendation rules corresponding to a plurality of logistics service schemes in response to the service recommendation task.

In some embodiments, the calculation module is specifically configured to, for any logistics service scheme, determine the attribute data corresponding to at least one evaluation factor in the recommendation rules associated with the logistics service scheme;
based on the attribute data corresponding to any evaluation factor of the logistics service scheme, calculate a matching score for the evaluation rule corresponding to that evaluation factor;
fuse the matching scores of at least one evaluation rule corresponding to the evaluation factor, based on the constraint relationships among the evaluation rules of that factor, to obtain an evaluation score for that evaluation factor;
fuse the evaluation scores corresponding to each evaluation factor to obtain a total evaluation score for the logistics service scheme;
use the total evaluation score as the degree of match between the logistics service scheme and the target user.

In some embodiments, at least one evaluation rule corresponding to any evaluation factor includes one or more of the following:
a score determination method based on the similarity conditions between the target user's preference data for the evaluation factor and the attribute data of the evaluation factor in the current logistics service scheme;
a score determination method based on whether the current logistics service scheme includes predefined tags and the scores corresponding to those tags;
a score determination method based on the ranking position of the attribute data of the current logistics service scheme among a plurality of logistics service schemes;
a score determination method based on the time range in which the difference between the effective time in the attribute data of the current logistics service scheme and the current time falls.

The calculation module may calculate a matching score corresponding to any evaluation rule of any evaluation factor of a logistics service scheme based on the attribute data of that evaluation factor. This may include:
determining the corresponding matching score based on the attribute data of the evaluation factor and the score determination method corresponding to a similarity condition satisfied with the attribute preference data of the evaluation factor corresponding to the target user;
determining the corresponding matching score according to the score determination method corresponding to at least one tag comprised in the logistics service scheme;
determining the corresponding matching score based on a ranking position of the attribute data of the evaluation factor among the plurality of logistics service schemes according to the corresponding score determination method;
or,
determining the corresponding matching score based on the time range in which the difference between the effective time of the attribute data of the evaluation factor and the current time falls according to the corresponding score determination method.

In some embodiments, the device may further include a first recommendation module, configured to recommend at least one target logistics service scheme to the target user according to the recommendation method specified in the recommendation rules.

In some embodiments, the device may further include a second recommendation module, configured to determine at least one recommendation field specified in the recommendation rules; generate recommendation information based on the field data of at least one recommendation field corresponding to any of the target logistics service schemes;
and send the recommendation information corresponding to each target logistics service scheme to the target user.

In some embodiments, the device may further include:
a service request module, configured to receive a logistics service request sent by the target user for any target logistics service scheme, and to generate a logistics service order;
sending the logistics service order to the corresponding target logistics service provider of the target logistics service scheme.

The logistics service scheme determination device described in FIG. 7 may execute the logistics service scheme determination method illustrated in the embodiment shown in FIG. 2. Its implementation principles and technical effects will not be repeated here. The specific operation methods performed by each module or unit of the logistics service scheme determination device in the above-mentioned embodiments have already been described in detail in the corresponding method embodiments, and will not be further elaborated here.

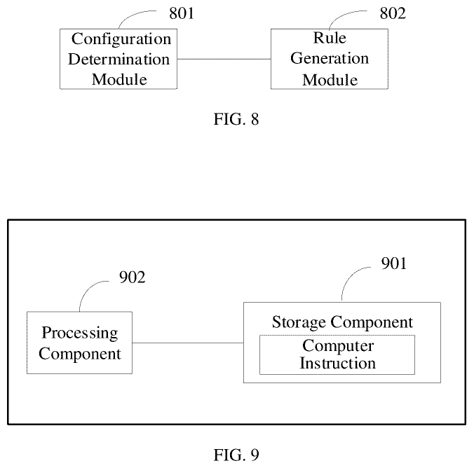

FIG. 8 illustrates a structural schematic diagram of a configuration device according to an embodiment of the present application. The device may include:
a configuration determination module 801, configured to determine at least one configured evaluation factor, at least one evaluation rule configured for any evaluation factor, and the constraint relationships among the evaluation rules, in response to a user's configuration operation;
a rule generation module 802, configured to generate recommendation rules based on at least one evaluation rule corresponding to each evaluation factor and the constraint relationships among the evaluation rules;
the recommendation rules are used to determine the degree of match between the target user and a plurality of logistics service schemes, so as to determine at least one target logistics service scheme to be recommended to the target user based on the matching degree.

In some embodiments, the configuration determination module is further configured to determine the configured recommendation method in response to a user's configuration operation.

The rule generation module may specifically generate the recommendation rules based on at least one evaluation rule corresponding to each evaluation factor, the constraint relationships among the evaluation rules, and the recommendation method.

The recommendation method is used to indicate how the target logistics service scheme is recommended to the target user.

In some embodiments, the configuration determination module is further configured to determine at least one configured recommendation field in response to a user's configuration operation.

The rule generation module may specifically generate the recommendation rules based on at least one evaluation rule corresponding to each evaluation factor, the constraint relationships among the evaluation rules, and at least one recommendation field.

The field data corresponding to at least one recommendation field for the target logistics service scheme is used to generate the recommendation information corresponding to the target logistics service scheme.

In some embodiments, the configuration determination module is further configured to determine the configured logistics service type in response to a user's configuration operation.

The rule generation module may specifically generate the recommendation rules corresponding to the logistics service type based on at least one evaluation rule corresponding to each evaluation factor and the constraint relationships among the evaluation rules.

In some embodiments, the configuration determination module may specifically be configured to:
provide a configuration interface;
provide evaluation factor configuration controls on the configuration interface;
determine at least one configured evaluation factor in response to a configuration operation performed on the evaluation factor configuration controls;
provide rule configuration controls corresponding to each evaluation factor on the configuration interface;
determine at least one configured evaluation rule and the constraint relationships among the evaluation rules in response to a configuration operation performed on any rule configuration control corresponding to an evaluation factor.

In some embodiments, the rule configuration controls include a relationship configuration control, a type configuration control, a content configuration control, and a score configuration control.

The configuration determination module is configured to determine at least one configured evaluation rule and the constraint relationships among the evaluation rules in response to a configuration operation performed on any rule configuration control corresponding to an evaluation factor. This may include:
providing relationship configuration prompt information on the configuration interface;
in response to a trigger operation on the relationship configuration prompt information, displaying the relationship configuration control on the configuration interface;
determining the configured constraint relationship in response to a configuration operation performed on the relationship configuration control;
providing rule configuration prompt information on the configuration interface;
in response to a trigger operation on the rule configuration prompt information, displaying the rule type configuration control, content configuration control, and score configuration control for the constraint relationship on the configuration interface;
determining the configured rule type in response to a configuration operation performed on the type configuration control;
determining the configured rule content in response to a configuration operation performed on the content configuration control;
determining the score determination method in response to a configuration operation performed on the score configuration control;
generating an evaluation rule based on the rule type, rule content, and score determination method;
determining one or more evaluation rules configured under the constraint relationship.

In some embodiments, the evaluation factor configuration controls include evaluation factor configuration sub-controls and total score configuration sub-controls.

The configuration determination module is configured to determine at least one evaluation factor in response to a configuration operation performed on the evaluation factor configuration controls, which may include: determining at least one evaluation factor in response to a configuration operation performed on the evaluation factor configuration sub-controls; and determining the corresponding weighted total score in response to a configuration operation performed on the total score configuration sub-control corresponding to any evaluation factor.

The score determination method of any evaluation rule is the proportional share within the weighted total score.

In some embodiments, the configuration determination module is further configured to display rule prompt information corresponding to a plurality of recommendation rules on the configuration interface; the rule prompt information includes at least one operation control; in response to a trigger operation on any operation control corresponding to any recommendation rule, the corresponding recommendation rule is processed according to the type of operation.

Optionally, the at least one operation control includes a start control, delete control, view control, edit control, and/or test control.

Optionally, the rule prompt information may further include status prompt information; the status prompt information includes running status, testing status, deactivated status, etc.

The configuration device described in FIG. 8 may execute the configuration method described in the embodiment shown in FIG. 4. The implementation principles and technical effects will not be repeated here. The specific operations performed by each module or unit on the configuration device in the above embodiments have been described in detail in the corresponding method embodiments and will not be further elaborated here.

In addition, an embodiment of the present application also provides a computing device, as shown in FIG. 9. The computing device may include a storage component 901 and a processing component 902.

The storage component 901 stores one or more computer instructions, which are invoked and executed by the processing component 902 to implement the logistics determination method shown in FIG. 2 or the configuration method shown in FIG. 4.

Of course, the computing device may also include other components, such as input/output interfaces, display components, communication components, etc. When the processing component in the computing device is used to implement the configuration method shown in FIG. 4, the computing device may further include a display component to perform the corresponding display operations.

The input/output interface provides a connection between the processing component and peripheral interface modules, wherein the peripheral interface modules may include output devices, input devices, etc. The communication component is configured to facilitate wired or wireless communication between the computing device and other devices.

The processing component may include one or more processors to execute computer instructions for performing all or part of the steps in the above-mentioned methods. Of course, the processing component may also be implemented using one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components for executing the described methods.

The storage component is configured to store various types of data to support operations on the terminal. The storage component may be implemented using any type of volatile or non-volatile storage device, or a combination thereof, such as static random-access memory (SRAM), electrically erasable programmable read-only memory (EEPROM), erasable programmable read-only memory (EPROM), programmable read-only memory (PROM), read-only memory (ROM), magnetic storage, flash memory, magnetic disks, or optical disks.

The display component may be an electroluminescent (EL) element, a liquid crystal display (LCD), a microdisplay with a similar structure, or a retina-direct display or similar laser scanning display.

It should be noted that when the above computing device implements the logistics determination method shown in FIG. 2 or the configuration method shown in FIG. 4, it may be a physical device or an elastic computing host provided by a cloud computing platform. It may be implemented as a distributed cluster composed of a plurality of servers or terminal devices, or as a single server or a single terminal device.

In addition, when the computing device implements the configuration method shown in FIG. 4, it may specifically be implemented as an electronic device. The electronic device may refer to a device used by the user with functions such as computing, internet access, and communication, for example, a mobile phone, tablet, personal computer, wearable device, etc.

An embodiment of the present application further provides a computer-readable storage medium storing a computer program, which, when executed by a computer, may implement the logistics service scheme determination method as shown in FIG. 2 or the configuration method as shown in FIG. 4. The computer-readable medium may be included in the electronic device described in the above embodiments, or it may exist independently without being integrated into the electronic device.

An embodiment of the present application further provides a computer program product, which includes a computer program carried on a computer-readable storage medium. When executed by a computer, the computer program may implement the logistics service scheme determination method as shown in FIG. 2 or the configuration method as shown in FIG. 4. In such an embodiment, the computer program may be downloaded and installed from a network and/or installed from a removable medium. When executed by a processor, the computer program performs various functions defined in the system of the present application.

It will be readily understood by those skilled in the art that, for convenience and brevity, the specific working processes of the systems, devices, and units described above may refer to the corresponding processes in the aforementioned method embodiments, and thus will not be repeated here.

The device embodiments described above are merely illustrative. The units described as separate components may or may not be physically separate; components presented as units may or may not be physical units. They may be located in one place or distributed across a plurality of network units. Parts or all of the modules may be selected as needed to achieve the objectives of the embodiments. Those of ordinary skill in the art can understand and implement them without creative effort.

Through the descriptions of the above embodiments, it will be clearly understood by those skilled in the art that the various embodiments may be implemented by means of software in conjunction with a necessary general-purpose hardware platform, and of course, may also be implemented by hardware. Based on this understanding, the essential parts of the above technical solutions, or the parts that contribute to the prior art, may be embodied in the form of a software product. This computer software product may be stored on a computer-readable storage medium, such as ROM/RAM, magnetic disks, optical disks, etc., and includes a set of instructions for enabling a computer device (which may be a personal computer, server, or network device, etc.) to execute the methods described in the embodiments or certain parts of the embodiments.

Finally, it should be noted that the above embodiments are intended only to illustrate the technical solutions of the present application and not to limit them. Although the present application has been described in detail with reference to the foregoing embodiments, those of ordinary skill in the art should understand that modifications may still be made to the technical solutions described in the foregoing embodiments, or equivalent substitutions may be made for some of the technical features. These modifications or substitutions do not depart from the essence and scope of the technical solutions of the embodiments of the present application.

What is claimed is:

1. A configuration method, comprising:
in response to a user's configuration operation, determining at least one evaluation factor configured by the user's configuration operation, at least one evaluation rule configured for the at least one evaluation factor, and constraint relationship among the at least one evaluation rule;
generating a recommendation rule based on the at least one evaluation rule respectively corresponding to the at least one evaluation factor and the constraint relationship among the at least one evaluation rule,
wherein the recommendation rule is used to determine a matching degree between a target user and each of a plurality of logistics service schemes, so as to determine, based on the matching degrees, at least one target logistics service scheme to be recommended for the target user.

2. The method according to claim 1, further comprising at least one of:
determining a recommendation mode in response to the user's configuration operation;
determining at least one recommendation field in response to the user's configuration operation; and
determining a logistics service type in response to the user's configuration operation;
wherein generating the recommendation rule based on the at least one evaluation rule respectively corresponding to the at least one evaluation factor and the constraint relationship among the at least one evaluation rule comprises:
generating the recommendation rule based on the at least one evaluation rule respectively corresponding to the at least one evaluation factor and the constraint relationship among the at least one evaluation rule, in combination with at least one of the recommendation mode, the at least one recommendation field, and the logistics service type;
wherein the recommendation mode is used to indicate that the target logistics service scheme is recommended to the target user according to the recommendation mode; and
wherein the target logistics service scheme corresponds to field data of the at least one recommendation field for generating recommendation information corresponding to the target logistics service scheme.

3. The method according to claim 1, wherein, in response to a user's configuration operation, determining at least one evaluation factor configured by the user's configuration operation, at least one evaluation rule configured for the at least one evaluation factor, and constraint relationship among the at least one evaluation rule comprises:
providing a configuration interface;
providing an evaluation factor configuration control on the configuration interface;
determining at least one evaluation factor in response to a configuration operation on the evaluation factor configuration control;
providing a rule configuration control respectively corresponding to the at least one evaluation factor on the configuration interface; and
determining at least one evaluation rule and the constraint relationship among the at least one evaluation rule in response to a configuration operation on the rule configuration control corresponding to the evaluation factor.

4. The method according to claim 3, wherein the rule configuration control comprises a relationship configuration control, a type configuration control, a content configuration control, and a score configuration control;
wherein determining at least one configured evaluation rule and the constraint relationship among the at least one evaluation rule in response to a configuration operation on the rule configuration control corresponding to the evaluation factor comprises:
providing relationship configuration prompt information on the configuration interface;
displaying the relationship configuration control on the configuration interface in response to a trigger operation on the relationship configuration prompt information;
determining a constraint relationship in response to a configuration operation on the relationship configuration control;
providing rule configuration prompt information on the configuration interface;
displaying a rule type configuration control, content configuration control, and score configuration control for the constraint relationship on the configuration interface in response to a trigger operation on the rule configuration prompt information;
determining a rule type in response to a configuration operation on the type configuration control;
determining a rule content in response to a configuration operation on the content configuration control;
determining a score determination method in response to a configuration operation on the score configuration control;
generating an evaluation rule based on the rule type, the rule content, and the score determination method; and
determining one or more evaluation rules configured under the constraint relationship.

5. The method according to claim 4, wherein the evaluation factor configuration control comprises an evaluation factor configuration sub-control and a total score configuration sub-control;
wherein the step of determining at least one evaluation factor in response to a configuration operation on the evaluation factor configuration control comprises:
determining at least one evaluation factor in response to a configuration operation on the evaluation factor configuration sub-control;
determining a corresponding weighted total score in response to a configuration operation on the total score configuration sub-control corresponding to the evaluation factor;
wherein the score determination method of the evaluation rule is a proportion within the weighted total score.

6. A non-transitory computer-readable storage medium configured with instructions executable by one or more processors to cause the one or more processors to perform the method of claim 1.

7. A method for determining a logistics service scheme, comprising:
determining a recommendation rule corresponding to a plurality of logistics service schemes, wherein the recommendation rule is generated based on at least one evaluation factor respectively corresponding to at least one evaluation rule and constraint relationship among the at least one evaluation rule;
calculating a degree of matching between each of the logistics service schemes and a target user based on attribute data of the at least one evaluation factor respectively corresponding to the plurality of logistics service schemes, according to the at least one evaluation rule respectively corresponding to the at least one evaluation factor and the constraint relationship among the at least one evaluation rule;
determining at least one target logistics service scheme based on the degree of matching between each of the plurality of logistics service schemes and the target user;
wherein the at least one target logistics service scheme is to be recommended to the target user.

8. The method according to claim 7, wherein determining a recommendation rule corresponding to a plurality of logistics service schemes comprises:
determining a plurality of logistics service schemes that match the target user based on user characteristic data of the target user; and
determining the recommendation rule respectively corresponding to the plurality of logistics service schemes based on the logistics service type respectively corresponding to the plurality of logistics service schemes.

9. The method according to claim 7, wherein calculating a degree of matching between each of the logistics service schemes and a target user based on attribute data of at least one evaluation factor respectively corresponding to plurality of the logistics service schemes, according to the at least one evaluation rule respectively corresponding to the at least one evaluation factor and the constraint relationship among the at least one evaluation rule, comprises:
for any given logistics service scheme, determining attribute data respectively corresponding to the at least one evaluation factor according to the at least one evaluation factor in the recommendation rule corresponding to the logistics service scheme;
for any given evaluation factor, calculating a matching score corresponding to any one of the evaluation rules corresponding to the evaluation factor, based on the attribute data corresponding to the evaluation factor;
fusing the matching score respectively corresponding to the at least one evaluation rule according to the constraint relationship of the at least one evaluation rule corresponding to the evaluation factor, to obtain an evaluation score corresponding to the evaluation factor;
fusing the evaluation score respectively corresponding to the at least one evaluation factor to obtain a total evaluation score corresponding to the logistics service scheme; and
using the total evaluation score as the degree of matching between the logistics service scheme and the target user.

10. The method according to claim 9, wherein the at least one evaluation rule corresponding to the evaluation factor comprises one or more of:
a score determination method based on a similarity condition satisfied between attribute preference data of the evaluation factor corresponding to the target user and the attribute data of the evaluation factor corresponding to a current logistics service scheme;
a score determination method corresponding to different preset tags comprised in the current logistics service scheme;
a score determination method corresponding to a ranking position of attribute data of the current logistics service scheme among a plurality of logistics service schemes; and
a score determination method corresponding to a time range in which the difference between effective time of attribute data of the current logistics service scheme and current time falls;
wherein calculating the matching score corresponding to any one of the evaluation rules based on the attribute data of any one evaluation factor corresponding to the logistics service scheme comprises:
determining the corresponding matching score based on the attribute data of the evaluation factor and the score determination method corresponding to a similarity condition satisfied with the attribute preference data of the evaluation factor corresponding to the target user;
determining the corresponding matching score according to the score determination method corresponding to at least one tag comprised in the logistics service scheme;
determining the corresponding matching score based on a ranking position of the attribute data of the evaluation factor among the plurality of logistics service schemes according to the corresponding score determination method; or
determining the corresponding matching score based on the time range in which the difference between the effective time of the attribute data of the evaluation factor and the current time falls according to the corresponding score determination method.

11. The method according to claim 8, further comprising:
recommending the at least one target logistics service scheme to the target user according to a recommendation method in the recommendation rule.

12. The method according to claim 8, further comprising:
determining at least one recommendation field in the recommendation rule;
generating recommendation information based on field data of the at least one recommendation field corresponding to the target logistics service scheme; and
sending the recommendation information respectively corresponding to the at least one target logistics service scheme to the target user.

13. The method according to claim 11, further comprising:
receiving a logistics service request sent by the target user for any given target logistics service scheme;
generating a logistics service order; and
sending the logistics service order to a logistics service provider corresponding to the target logistics service scheme.

14. The method according to claim 12, further comprising:
receiving a logistics service request sent by the target user for any given target logistics service scheme;
generating a logistics service order; and
sending the logistics service order to a logistics service provider corresponding to the target logistics service scheme.

15. A non-transitory computer-readable storage medium configured with instructions executable by one or more processors to cause the one or more processors to perform the method of claim 7.

16. An electronic device comprising:
one or more processors; and
one or more computer-readable memories coupled to the one or more processors and having instructions stored thereon that are executable by the one or more processors to perform operations comprising:
in response to a user's configuration operation, determining at least one evaluation factor configured by the user's configuration operation, at least one evaluation rule configured for the at least one evaluation factor, and constraint relationship among the at least one evaluation rule;
generating a recommendation rule based on the at least one evaluation rule respectively corresponding to the at least one evaluation factor and the constraint relationship among the at least one evaluation rule,
wherein the recommendation rule is used to determine a matching degree between a target user and each of a plurality of logistics service schemes, so as to determine, based on the matching degrees, at least one target logistics service scheme to be recommended for the target user.

17. The electronic device according to claim 16, the operations further comprising at least one of:
determining a recommendation mode in response to the user's configuration operation;
determining at least one recommendation field in response to the user's configuration operation; and
determining a logistics service type in response to the user's configuration operation;
wherein generating the recommendation rule based on the at least one evaluation rule respectively corresponding to the at least one evaluation factor and the constraint relationship among the at least one evaluation rule comprises:
generating the recommendation rule based on the at least one evaluation rule respectively corresponding to the at least one evaluation factor and the constraint relationship among the at least one evaluation rule, in combination with at least one of the recommendation mode, the at least one recommendation field, and the logistics service type;
wherein the recommendation mode is used to indicate that the target logistics service scheme is recommended to the target user according to the recommendation mode; and
wherein the target logistics service scheme corresponds to field data of the at least one recommendation field for generating recommendation information corresponding to the target logistics service scheme.

18. The electronic device according to claim 16, wherein, in response to a user's configuration operation, determining at least one evaluation factor configured by the user's configuration operation, at least one evaluation rule configured for the at least one evaluation factor, and constraint relationship among the at least one evaluation rule comprises:
providing a configuration interface;
providing an evaluation factor configuration control on the configuration interface;
determining at least one evaluation factor in response to a configuration operation on the evaluation factor configuration control;
providing a rule configuration control respectively corresponding to the at least one evaluation factor on the configuration interface; and
determining at least one evaluation rule and the constraint relationship among the at least one evaluation rule in response to a configuration operation on the rule configuration control corresponding to the evaluation factor.

19. The electronic device according to claim 18, wherein the rule configuration control comprises a relationship configuration control, a type configuration control, a content configuration control, and a score configuration control;
wherein determining at least one configured evaluation rule and the constraint relationship among the at least one evaluation rule in response to a configuration operation on the rule configuration control corresponding to the evaluation factor comprises:
providing relationship configuration prompt information on the configuration interface;
displaying the relationship configuration control on the configuration interface in response to a trigger operation on the relationship configuration prompt information;
determining a constraint relationship in response to a configuration operation on the relationship configuration control;
providing rule configuration prompt information on the configuration interface;
displaying a rule type configuration control, content configuration control, and score configuration control for the constraint relationship on the configuration interface in response to a trigger operation on the rule configuration prompt information;
determining a rule type in response to a configuration operation on the type configuration control;
determining a rule content in response to a configuration operation on the content configuration control;
determining a score determination method in response to a configuration operation on the score configuration control;
generating an evaluation rule based on the rule type, the rule content, and the score determination method; and
determining one or more evaluation rules configured under the constraint relationship.

20. The electronic device according to claim 19, wherein the evaluation factor configuration control comprises an evaluation factor configuration sub-control and a total score configuration sub-control;
wherein the step of determining at least one evaluation factor in response to a configuration operation on the evaluation factor configuration control comprises:
determining at least one evaluation factor in response to a configuration operation on the evaluation factor configuration sub-control;
determining a corresponding weighted total score in response to a configuration operation on the total score configuration sub-control corresponding to the evaluation factor;
wherein the score determination method of the evaluation rule is a proportion within the weighted total score.
